(19) United States
(12) Patent Application Publication
(10) Pub. No.: US 2022/0187850 A1
(43) Pub. Date: Jun. 16, 2022

(54) SLIPPAGE IDENTIFICATION AND INTELLIGENT ADAPTIVE CONTROL METHOD FOR PATROL ROBOT

(71) Applicant: GUANGDONG KEYSTAR INTELLIGENCE ROBOT CO., LTD., Foshan (CN)

(72) Inventors: Fang Li, Foshan (CN); Shaochun Jia, Foshan (CN); Jixian Wu, Foshan (CN); Jiaju Xue, Foshan (CN); Guangmian Fan, Foshan (CN); Yangyong Zhang, Foshan (CN)

(73) Assignee: GUANGDONG KEYSTAR INTELLIGENCE ROBOT CO., LTD., Foshan (CN)

(21) Appl. No.: 17/441,911

(22) PCT Filed: Mar. 26, 2020
(86) PCT No.: PCT/CN2020/081423

§ 371 Date: Sep. 22, 2021

(30) Foreign Application Priority Data
Dec. 9, 2019 (CN) 201911247181.7

(51) Int. Cl. G05D 1/08; G05D 1/00; G05D 1/02; H02G 1/02

(52) U.S. Cl. CPC G05D 1/0891; G05D 1/0088; G05D 1/0272; G05D 2201/0207; G05D 1/0229; H02G 1/02; G05D 1/0011

(57) ABSTRACT

Disclosed is a slippage identification and intelligent adaptive control method for a patrol robot. The patrol robot comprises a walking wheel and a pinch wheel. The walking wheel rolls on a wire to be inspected, and the pinch wheel is located below the wire and is used to press the wire on the walking wheel. The method comprises the following steps: (1) during an inspection process, the patrol robot detects in real time whether the walking wheel is slipping by means of comparing the angular velocities of the walking wheel and the pinch wheel, wherein during the detection of whether the walking wheel is slipping, the pinch wheel is in contact with the wire; (2) if no slippage is detected, then continuing to inspect, and if slippage is detected, then determining the degree of slippage according to a slippage model, wherein the degree of slippage is determined by means of the ratio between the angular velocities of the walking wheel and the pinch wheel; and (3) performing adaptive slippage control according to the degree of slippage. The control method of the present invention has the characteristics of relatively accurate control of the slippage state.

### TECHNICAL FIELD

The present disclosure relates to the field of inspection robot technologies, and more particularly, to a slipping identification and intelligent self-adaptive control method for an inspection robot.

### BACKGROUND

Traditional methods for inspection of power transmission lines are mainly based on manual inspection, and are lower in inspection efficiency, higher in labor intensity, and severer in working environment because workers generally need to work in the field. Furthermore, some power transmission lines span across high mountains, dense forests, and large rivers, making the inspection more difficult. Utilization of helicopters for inspection is higher in inspection efficiency but is poorer in economic benefit, and is easy to overlook subtle damage to the power transmission lines. As a special robot configured to inspect high-voltage power transmission lines, an inspection robot may replace manual inspection. By virtue of its advantages of higher inspection efficiency and better imaging effect, inspection based on the inspection robot is an inevitable trend of the combination of development of robot technologies and transmission line inspection technologies.

In an inspection process of the inspection robot, the problem of slipping is a prominent technical problem. Causes for the slipping of the inspection robot include negative effects of slopes of cables, adhesion coefficient of walking wheels with respect to the cables, and forces applied by the walking wheels to the cables. In addition to these three factors, the slipping may also be caused by variations of motion states of the robot, which may be caused by, for example, surface corrosion of an earth wire, dust coverage, slippery when wet, traveling speed of the robot, surface roughness of a wheel groove of the walking wheel, vibration during traveling process, and interferences from external forces such as wind load, etc.

A typical slip control of the inspection robot is as below. when the slipping is detected, pressing forces of pressing wheels are controlled, and the forces applied by the walking wheels to the cables are increased to overcome the slipping. In an existing slip control, it is only determined whether the inspection robot is in an accelerated slipping-down state or a normal slipping state. When the inspection robot is in the accelerated slipping-down state, a pressing motor quickly supplements pressing forces to prevent occurrence of slipping-down. If the inspection robot is in the normal slipping state, the pressing motor slowly supplements the pressing forces of the pressing wheels until the slipping is stopped. These two types of slip control are prone to locking, and having a negative effect on inspection efficiency. Moreover, in the event of slipping, adjustment of the pressing forces of the pressing motor is not prepared enough, which makes the slip control process not smooth.

### SUMMARY

An objective of the present disclosure is to provide a slipping identification and intelligent self-adaptive control method for an inspection robot, wherein this control method has the characteristic of relatively accurate control of a slipping state.

To achieve this objective, the present disclosure adopts following technical solutions.

There is provided a slipping identification and intelligent self-adaptive control method for an inspection robot. The inspection robot includes a walking wheel and a pressing wheel, wherein the walking wheel rolls on a patrolled cable, and the pressing wheel is located below the patrolled cable and is configured to press the patrolled cable on the walking wheel. The method includes following steps.

(1) The inspection robot detects whether the walking wheel slips in real time by comparing an angular speed of the walking wheel and an angular speed of the pressing wheel in an inspection process, and in this detection process, the pressing wheel is contacted with the patrolled cable.

(2) If no slipping is detected, the inspection is continuously conducted. However, if the slipping is detected, a degree of slipping is determined according to a slipping model, and the degree of slipping is determined based on a ratio of the angular speed of the walking wheel to the angular speed of the pressing wheel.

(3) Self-adaptive slip control is carried out according to the degree of slipping.

Further, when the inspection robot walks, number of revolutions of the pressing wheel is detected by a sensor, and a formula for calculating an actual angular speed of the pressing wheel is as follows:

$${ω}_{p} ( Δ t ) = \frac{2 π {N}_{p}}{{n}_{p} ( {t}_{2} - {t}_{1} )} = \frac{2 π {N}_{p}}{{n}_{p} Δ t}$$

wherein Nₚ represents number of pulses measured from t₁ to t₂, and a measured value of Nₚ is a positive value or a negative value. Nₚ>0 indicates counts in a forward direction, Nₚ<0 indicates counts in a backward direction, nₚ represents number of pulses per revolution of the pressing wheel, and ωₚ(Δt) represents an average angular speed within a period of [symbol] t.

When the walking wheel of the inspection robot does not slip

$${\overline{ω}}_{p} = \frac{{ω}_{w} R}{r} ,$$

ω̅ₚ represents a theoretical angular speed of the pressing wheel, and ω [symbol] represents the angular speed of the walking wheel. When the inspection robot walks, number of revolutions of the walking wheel is detected by the sensor, and a formula for calculating an actual angular speed of the walking wheel is as follows:

$${ω}_{w} ( Δ t ) = \frac{2 π {N}_{w}}{{n}_{w} ( {t}_{2} - {t}_{1} )} = \frac{2 π {N}_{w}}{{n}_{w} Δ t} ,$$

wherein N_{w} represents number of pulses measured from t₁ to t₂, n_{w} represents number of pulses per revolution of the walking wheel, and ω [symbol] (Δt) represents an average angular speed within the period of [symbol] t.

When ωₚ(Δt)≠ω̅ₚ(Δt), the inspection robot slips when walking.

It is determined whether the inspection robot slips by detecting and comparing ωₚ(Δt) and ω̅ₚ(Δt) in the step (2)

Further, a slipping model is proposed according to a ratio between ωₚ(Δt) and ω̅ₚ(Δt) in the step (2), and a slip ratio σ is set in the slipping model.

$$σ ( Δ t ) = \frac{{ω}_{p} ( Δ t )}{{\overline{ω}}_{p} ( Δ t )} = \frac{{rN}_{p} {n}_{w}}{{RN}_{w} {n}_{p}} {\vert}_{Δ t} ,$$

σ(Δt) represents the slip ratio of the walking wheel within the period Δt.

A slipping state S is defined in the slipping model, and five types of slipping states are classified according to the slip ratio.

1) When Nₚ<0, σ<0, the walking wheel is in a slipping-down state, and S=S_{g}.

2) When σ=0 and N_{w}>0, the walking wheel is in a full-slip state, and S=S_{b}.

3) When 0<σ<1 and N_{w}>0, the walking wheel is in a light-slip state, and S=Sₛ.

4) When σ=1 and N_{w}>0, the walking wheel is in a normal walking state, and S=Sₙ.

5) When N_{w}=0, σ=∞, the walking wheel is in a locked state, and S=Sᵢ.

Further, in the step (3), a self-adaptive slip control is performed by using a two-dimensional fuzzy control method. The pressing wheel is driven by a pressing motor to press the cable on the walking wheel. Degree of pressing the cable on the walking wheel by the pressing wheel can be adjusted by adjusting a stroke of the pressing motor. The larger the stroke of the pressing motor is, the greater the degree of pressing the cable on the walking wheel is.

A slope θ of the cable and the slip ratio σ are regarded as input of the fuzzy control, and the stroke x of the pressing motor is regarded as output. A variable domain and a membership function are first determined for the slope θ of the cable and the slip ratio σ, and then a variable domain and a membership function are determined for the stroke x of the pressing motor.

Further, in rolling travel, the inspection robot has an effective slope range θ ∈[−35°, 35°] and a slip ratio range of σ∈(−∞, +∞), the slipping state of the inspection robot is S∈{S_{g}, S_{b}, S [symbol] , Sₙ, Sₜ}, the domain E [symbol] of the slope θ is {−35, −25, −15, 0, 15, 25, 35}, and corresponding linguistic variables are NB, NM, NS, ZO, PS, PM, and PB; and the domain E [symbol] of the slip ratio σ is {−∞, 0₋, 0₊, 1, +∞}, and corresponding linguistic variables are NB, NS, ZO, PS, and PB.

A triangle membership function is selected to obtain the membership function of the slip ratio.

Further, a method of determining the variable domain and the membership function of the stroke x of the pressing motor is as below.

The domain Eₓ of the stroke x of the pressing motor is determined as {−13.6, −8.4, −4.2, 0, 4.2, 8.4, 13.6}, and the corresponding linguistic variables are determined as NB, NM, NS, ZO, PS, PM, and PB.

Fuzzy control rules are expressed as:

Rᵢ: if θ is Aᵢ and θ is Bᵢ, then uᵢ is Cᵢ

A fuzzy relationship corresponding to the fuzzy control rules is as below:

$$R = {R}_{1} ⋃ {R}_{2} … ⋃ {R}_{n} = {{⋃}_{i = 1}}^{n} {R}_{i}$$

wherein Rᵢ represents an i^{th} control rule, uᵢ represents the stroke xᵢ of the pressing motor, Aᵢ represents a fuzzy subset of the linguistic variables corresponding to θ in the domain thereof, Bᵢ represents a fuzzy subset of the linguistic variables corresponding to θ in the domain thereof, and Cᵢ represents a fuzzy subset of the linguistic variables corresponding to u in the domain thereof.

Further, the inspection robot is provided with a tilt angle sensor, and the tilt angle sensor is configured to measure the slope θ of the cable.

Further, the self-adaptive slip control method based on the two-dimensional fuzzy control method includes: performing fuzzy processing on the slope θ of the cable and the slip ratio θ, and performing fuzzy processing in conjunction with the fuzzy control rules to obtain an output stroke. The stroke reaches the pressing motor, such that the pressing motor executes the stroke.

Further, in this method, a communication connection is established between the inspection robot and a base station. The inspection robot transmits a slipping state to the base station, and the base station transmits a remote control command to the inspection robot, wherein the remote control command includes a command of adjusting the degree of pressing for the pressing wheel.

The present disclosure has following beneficial effects.

According to the slipping identification and intelligent self-adaptive control method for an inspection robot provided by the present disclosure, degree of slipping is first determined according to a slipping model, and then self-adaptive slip control is carried out based on the degree of slipping. Relatively accurate slip control can be achieved by this self-adaptive slip control method. Therefore, the self-adaptive slip control method provided by the present disclosure is reasonable and can effectively prevent slipping. Five types of slipping states are classified in the present disclosure. A self-adaptive slip control is performed by using a two-dimensional fuzzy control method. In this two-dimensional fuzzy control method, a slope θ of the cable and the slip ratio σ are regarded as input of the fuzzy control, and the stroke x of the pressing motor is regarded as output. A variable domain and a membership function are first determined for the slope θ of the cable and the slip ratio σ, and then a variable domain and a membership function are determined for the stroke x of the pressing motor. According to this two-dimensional fuzzy control method, the stroke of the pressing motor can be outputted based on the slipping states to accurately control a pressing force, such that the walking wheel is effectively prevented from being locked in a slip control process, ensuring the slip control process smoother.

### BRIEF DESCRIPTION OF THE DRAWINGS

FIG. 1 is a force analysis diagram of an inspection robot walking on a cable;

FIG. 2 is a force analysis diagram of a forearm walking wheel of the inspection robot walking on the cable;

FIG. 3 is a slip analysis diagram of the walking wheel of the inspection robot walking on the cable;

FIG. 4 is a schematic diagram showing distribution of slipping states of the inspection robot walking on the cable; and

FIG. 5 illustrates membership function diagrams.

### DETAILED DESCRIPTION

The technical solutions of the present disclosure are further described below with reference to the accompanying drawings and specific embodiments.

The present disclosure provides a slipping identification and intelligent self-adaptive control method for an inspection robot. The inspection robot includes a walking wheel and a pressing wheel, wherein the walking wheel rolls on a patrolled cable, and the pressing wheel is located below the patrolled cable and is configured to press the patrolled cable on the walking wheel. The method includes following steps.

(1) The inspection robot detects whether the walking wheel slips in real time by comparing an angular speed of the walking wheel and an angular speed of the pressing wheel in an inspection process, and in this detection process, the pressing wheel is contacted with the patrolled cable.

(2) If no slipping is detected, the inspection is continuously conducted. However, if the slipping is detected, a degree of slipping is determined according to a slipping model, and the degree of slipping is determined based on a ratio of the angular speed of the walking wheel to the angular speed of the pressing wheel.

(3) Self-adaptive slip control is carried out according to the degree of slipping.

The walking wheel of the inspection robot acts on an earth wire and rolls on the earth wire, and its force condition is as shown in FIG. 1. It is assumed that double-arm walking wheels of the robot are synchronously driven by a torque M_{R} provided by the motor, and travel in an x direction at a constant speed on the earth wire with a slope of θ. F_{X} and respectively represent a tangential force between the two walking wheels and the earth wire in the x direction. F_{R} and F′_{R} respectively represent a rolling resistance in a direction reverse to the x direction. F_{z} and F′_{z} respectively represent an acting force applied by the earth wire to the robot in a z direction. G represents a gravity of the robot. R and r respectively represent a radius of the walking wheel and a radius of the pressing wheel; and 1 represents a distance between the arms. A center of gravity of the inspection robot is located in a center of a control box of the robot.

The pressing wheel is in a released state when there is no contact between the pressing wheel and the earth wire. The control box is taken as a research object, a formula

F [symbol] =F′₂=½G cosθ

may be easily obtained according to a balance equation. Forces of the two walking wheels are the same, the forearm walking wheel is taken as the research object, and the force of the forearm walking wheel is as shown in FIG. 2.

The balance equation is as follows:

ΣX=0, Fₓ−F_{R}−½G sinθ= (1), and

ΣZ=0, F_{z}−½G cosθ=0 (2)

The walking wheel of the inspection robot is designed as a V-shaped groove rotary structure. An outer surface of the groove is covered with a certain thickness of cowhide material, such that the walking wheel has high elasticity and high friction coefficient when the walking wheel is contacted with the earth wire, which not only increases a friction force between the walking wheel and the earth wire, but also protects the earth wire.

The contact between the walking wheel and the earth wire may be approximated as an action between a car tire and a hard ground. As an adhesive connection, the contact only can transmit limited tangential force, which may be calculated by the following formula, wherein uₕ represents a maximum adhesion coefficient.

Fₓ= [symbol] ₕF_{z}

When the walking wheel moves on the earth wire (cable), the rolling resistance F_{R} generally is small enough to be ignored. As can be known from Formula (1) and Formula (2), the robot may slip when it meets Formula (3).

$${F}_{z} < \frac{1}{2 \text{?}} G sin θ . \\ \text{?} \text{indicates text missing or illegible when filed} \qquad ( 3 )$$

As can be known from Formula (2) and Formula (3), a maximum slope for rolling travel of the robot is θₘₐₓ when the pressing wheel is released θₘₐₓ =arctan u [symbol] When the slope of the earth wire is greater than θₘₐₓ, the robot crawls up in a wriggling manner.

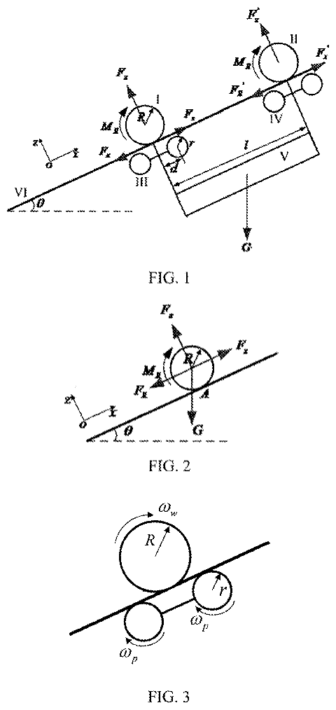

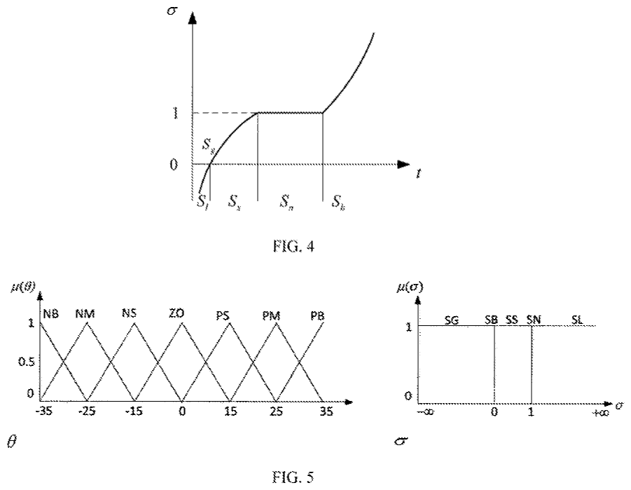

Further, a slip detection model is established, and a pressing mechanism on two arms of the robot is provided with a slip detection sensor, wherein the sensor is installed on one of the pressing wheels. The pressing wheel has no driving unit and is in a free state. To detect slipping, the pressing mechanism controls the pressing wheel to be in contact with the earth wire, as shown in FIG. 3, a pressing force applied at this moment is small enough to be ignored. When the walking wheel travels at a certain angular speed ω_{w} along the earth wire, the pressing wheel may rotate due to the contact with the earth wire, and a rotational angular speed is denoted as ωₚ.

When the pressing wheel rotates, the sensor generates a pulse signal, a control system collects number of pulse skipping to calculate number of revolutions of the pressing wheel, and then control system calculates a rotation speed of the pressing wheel. The actual angular speed of the pressing wheel is calculated by the following formula:

$${ω}_{p} ( Δ t ) = \frac{2 π {N}_{p}}{{n}_{p} ( {t}_{2} - {t}_{1} )} = \frac{2 π {N}_{p}}{{n}_{p} Δ t}$$

wherein Nₚ represents number of pulses measured from t₁ to t₂, and a measured value of Nₚ is a positive value or a negative value. Nₚ>0 indicates counts in a forward direction, Nₚ<0 indicates counts in a backward direction, nₚ represents number of pulses per revolution of the pressing wheel, and ωₚ represents an average angular speed within a period of [symbol] t.

When the walking wheel of the inspection robot does not slip, the walking wheel and the pressing wheel may rotate synchronously, and they travel the same distance within a certain period of time. As can be seen, a linear speed ν_{w} of the walking wheel is equal to a linear speed ν_{F} of the pressing wheel, i.e., ν_{w}=νₚ, ν_{w}=ω_{w}R and νₚ=ω̅ₚr, wherein ω̅_{P} represents a theoretical angular speed of the pressing wheel. When the walking wheel does not slip, a relation equation will be concluded as below

$${ϖ}_{p} = \frac{{ω}_{w} R}{r} ,$$

wherein ω_{w} represents the angular speed of the walking wheel.

The walking wheel of the inspection robot is controlled by a servo control unit, and a sensor is installed on a walking motor. The angular speed ω_{w} is obtained by calculating based on data fed back by the sensor, and a formula for calculating the actual angular speed of the walking wheel is as follows:

$${ω}_{w} ( Δ t ) = \frac{2 π {N}_{w}}{{n}_{w} ( {t}_{2} - {t}_{1} )} = \frac{2 π {N}_{w}}{{n}_{w} Δ t}$$

wherein N_{w} represents number of pulses measured from t₁ to t₂, n_{w} represents number of pulses per revolution of the walking wheel, and ω_{w}(Δt) represents an average angular speed within a period of [symbol] t. When ωₚ(≠t)±ω̅ₚ(Δt), the inspection robot slips when walking. It is determined whether the inspection robot slips by detecting and comparing ωₚ(Δt) and ω̅ₚ(Δt) in the step (2).

Further, a slipping model is proposed according to a ratio between ωₚ(Δt) and ω̅ₚ(Δt) in the step (2), and a slip ratio σ is set in the slipping model.

$${σ ( Δ t ) = \frac{{ω}_{p} ( Δ t )}{{ϖ}_{p} ( Δ t )} = \frac{{rN}_{p} {n}_{w}}{{RN}_{w} {n}_{p}} \vert}_{Δ t} ,$$

σ(Δt) represents the slip ratio of the walking wheel within the period Δt.

A slipping state S is defined in the slipping model, and five types of slipping states are classified according to different slip ratios:

1) When Nₚ<0, σ<0, the walking wheel is in a slipping-down state, and S=S_{g}.

2) When σ=0 and N_{w}>0, the walking wheel is in a full-slip state, and S=S_{b}.

3) When 0<σ<1 and N_{w}>0, the walking wheel is in a light-slip state, and S=Sₛ.

4) When σ=1 and N_{w}>0, the walking wheel is in a normal walking state, and S=Sₙ.

5) When N_{w}32 0, σ=∞, the walking wheel is in a locked state, and S=S₁.

A pressing regulation mechanism of the present disclosure is as follows.

The pressing force of the pressing wheel of the inspection robot mainly depends on the pressing mechanism driving the motor to drive the pressing wheel to press the earth wire. However, it is difficult to accurately calculate magnitude of the pressing force based on electric current of the motor. If the pressing force is increased, the walking motor is prone to be locked due to changes of a diameter of the earth wire. Therefore, the pressing mechanism is connected to the pressing wheel through a pressing buffer device, to adapt to the change of the diameter of the earth wire. The pressing buffer device mainly is an extension spring additionally provided on a connection part of the pressing wheel. According to Hooke's law, force of a spring is in direct proportion to deformation quantity of the spring, and a formula for calculating the force of the spring is as follows: F [symbol] =−kx, wherein Fₛ represents the force (measured in N) of the spring, x represents the deformation quantity (measured in m) of the spring, and k represents a spring coefficient (measured in N/m). The formula for calculating the spring coefficient k is as below:

$$k = \frac{{G}_{s} {d}^{4}}{8 {N}_{c} {D}_{m}^{3}} ,$$

wherein Gₛ represents a rigidity modulus of the cable, d represents a wire diameter (measured in mm), N_{c} represents effective number of turns, and Dₘ represents a center diameter (measured in mm).

The deformation quantity of the spring is changed by the pressing motor, such that the pressing force is transmitted to the pressing wheel. Therefore, the pressing force satisfies the formula F₂^{P}=F [symbol] ₍4). When the robot slips, the pressing force to be supplemented is

$${F}_{z} = \frac{1}{2 \text{?}} G sin θ - {F}_{z}^{N} = \frac{1}{2 {u}_{h}} G ( sin θ - \text{?} cos θ ) . \\ \text{?} \text{indicates text missing or illegible when filed}$$

The deformation quantity to be generated by compressing the spring for the pressing motor is as below:

$$x = \frac{4 {N}_{c} {D}_{m}^{3} G}{\text{?} {G}_{s} {d}^{4}} ( sin θ - \text{?} cos θ ) . \\ \text{?} \text{indicates text missing or illegible when filed}$$

According to analysis of the formula (4), slipping of the robot is related to θ [symbol] uₕ [symbol] F_{z}. In actual operation, causes of slipping are more complicated. Slipping may be caused by variations of motion states of the robot, which may be caused by, for example, surface corrosion of the earth wire, dust coverage, slippery when wet, traveling speed of the robot, surface roughness of a wheel groove of the walking wheel, vibration during traveling process, and interferences from external forces such as wind load, etc. Therefore, a two-dimensional fuzzy control is designed.

Further, in step (3), a self-adaptive slip control is performed by using a two-dimensional fuzzy control method. In this method, a communication connection is established between the inspection robot and a base station, the inspection robot transmits a slipping state to the base station, and the base station transmits a remote control command to the inspection robot, wherein the remote control command includes a command of adjusting the degree of pressing for the pressing wheel.

The self-adaptive slip control method based on the two-dimensional fuzzy control method includes: performing fuzzy processing on the slope θ of the cable and the slip ratio σ, and performing fuzzy processing in conjunction with the fuzzy control rules to obtain an output stroke, wherein the stroke reaches the pressing motor, such that the pressing motor executes the stroke.

The pressing wheel is driven by a pressing motor to press the cable on the walking wheel, degree of pressing the cable on the walking wheel by the pressing wheel can be adjusted by adjusting a stroke of the pressing motor, and the larger the stroke of the pressing motor is, the greater the degree of pressing the cable on the walking wheel is.

The inspection robot is provided with a tilt angle sensor, wherein the tilt angle sensor is configured to measure the slope θ of the cable. The slope θ of the cable and the slip ratio σ are regarded as input of the fuzzy control, and the stroke x of the pressing motor is regarded as output. A variable domain and a membership function are first determined for the slope θ of the cable and the slip ratio σ, and then a variable domain and a membership function are determined for the stroke x of the pressing motor.

Further, in rolling travel, the inspection robot has an effective slope range of θ∈[−35°, 35°] and a slip ratio range of σ∈(−∞, +∞), the slipping state of the inspection robot is S∈{S_{g}, S_{b}, S [symbol] , Sₙ, Sᵢ}, the domain E [symbol] of the slope θ is {−35, −25, −15, 0, 15, 25, 35}, and corresponding linguistic variables are NB, NM, NS, ZO, PS, PM, and PB; and the domain E [symbol] of the slip ratio σ is {−∞, 0₋, 0₊, 1, +∞}, and corresponding linguistic variables are NB, NS, ZO, PS, and PB.

A triangle membership function is selected to obtain the membership function of the slip ratio.

Corresponding relationships between the domains and the variables of the inspection robot are as shown in the table below.

| θ | NB | NM | NS | ZO | PS | PM | PB |
|---|---|---|---|---|---|---|---|
| | −3 | −2 | −1 | 0 | 1 | 2 | 3 |
| σ | SG | SB | SS | SN | SL | | |
| | −2 | −1 | 0 | 1 | 2 | | |

Because an input region of the slope θ is smaller, to improve control sensitivity, a higher-resolution curve is employed, and the triangle membership function is selected, as shown in FIG. 5. Rules for selecting the membership function of the slip ratio is as shown in FIG. 5, which makes control characteristics more flat and improves stability of the control system.

Further, a method of determining the variable domain and the membership function of the stroke x of the pressing motor is as below.

The domain Eₓ of the stroke x of the pressing motor is determined as {−13.6, −8.4, −4.2, 0, 4.2, 8.4, 13.6}, and the corresponding linguistic variables are determined as NB, NM, NS, ZO, PS, PM, and PB.

Fuzzy control rules are expressed as:

Rᵢ: if θ is Aᵢ and σ is Bᵢ, then uᵢ is Cᵢ

A fuzzy relationship corresponding to the fuzzy control rules is as below:

$$R = {R}_{1} ⋃ {R}_{2} … ⋃ {R}_{n} = {{⋃}_{i = 1}}^{n} {R}_{i}$$

wherein Rᵢ represents an i^{th} control rule, uᵢ represents the stroke xᵢ of the pressing motor, Aᵢ represents a fuzzy subset of the linguistic variables corresponding to θ in the domain thereof, Bᵢ represents a fuzzy subset of the linguistic variables corresponding to σ in the domain thereof, and Cᵢ represents a fuzzy subset of the linguistic variables corresponding to u in the domain thereof.

During the slip control, the fuzzy control rules are adjusted according to experimental experiences. When the slope θ is smaller, neither the slipping-down state S_{g} nor the full-slip state S_{b} or the light-slip state Sₛ occurs in the inspection robot. Determination rules are as shown in the following table.

| | NB | NM | NS | ZO | PS | PM | PB |
|---|---|---|---|---|---|---|---|
| SG | PB | PM | PS | — | PS | PM | PB |
| SB | PM | PS | PS | — | PS | PS | PM |
| SS | PS | PS | PS | — | PS | PS | PS |
| SN | ZO | ZO | ZO | ZO | ZO | ZO | ZO |
| SL | NS | NM | NB | NB | NB | NM | NS |

Technical principles of the present disclosure have been described above with reference to specific embodiments. These descriptions are only for explaining the principles of the present disclosure, and cannot be construed as limiting the protection scope of the present disclosure in any way. Based on the explanation here, other specific embodiments of the present disclosure are conceivable to those skilled in the art without creative labor, and these embodiments will fall within the protection scope of the present disclosure.

What is claimed is:

1. A slipping identification and intelligent self-adaptive control method for an inspection robot, the inspection robot comprising a walking wheel and a pressing wheel, the walking wheel rolling on a patrolled cable, and the pressing wheel being located below the patrolled cable and configured to press the patrolled cable on the walking wheel; the method comprising:
(1) detecting, by the inspection robot in an inspection process, whether slipping of the walking wheel is caused in real time by comparing an angular speed of the walking wheel and an angular speed of the pressing wheel, wherein in detection of the slipping, the pressing wheel is contacted with the patrolled cable;
(2) if no slipping is detected, the inspection being continuously conducted, if the slipping is detected, a degree of slipping being determined according to a slipping model, and the degree of slipping being determined based on a ratio of the angular speed of the walking wheel to the angular speed of the pressing wheel; and
(3) self-adaptive slip control being carried out according to the degree of slipping.

2. The slipping identification and intelligent self-adaptive control method for an inspection robot according to claim 1, wherein when the inspection robot walks, number of revolutions of the pressing wheel is detected by a sensor, and a formula for calculating an actual angular speed of the pressing wheel is as follows:
$${ω}_{p} ( Δ t ) = \frac{2 π {N}_{p}}{{n}_{p} ( {t}_{2} - {t}_{1} )} = \frac{2 π {N}_{p}}{{n}_{p} Δ t}$$
wherein Nₚ represents number of pulses measured from t₁ to t₂, a measured value of Nₚ is a positive value or a negative value, Nₚ>0 indicates counts in a forward direction, Nₚ<0 indicates counts in a backward direction, nₚ represents number of pulses per revolution of the pressing wheel, and ωₚ(Δt) represents an average angular speed within a period of [symbol] t;
when the walking wheel of the inspection robot does not slip,
$${ϖ}_{p} = \frac{{ω}_{w} R}{r} ,$$
ω̅ₚ represents a theoretical angular speed of the pressing wheel, and ω [symbol] represents the angular speed of the walking wheel; when the inspection robot walks, number of revolutions of the walking wheel is detected by the sensor, and a formula for calculating an actual angular speed of the walking wheel is as follows:
$${ω}_{w} ( Δ t ) = \frac{2 π {N}_{w}}{{n}_{w} ( {t}_{2} - {t}_{1} )} = \frac{2 π {N}_{w}}{{n}_{w} Δ t} ,$$
wherein N_{w} represents number of pulses measured from t₁ to t₂, n_{w} represents number of pulses per revolution of the walking wheel, and ω [symbol] (Δt) represents an average angular speed within the period of [symbol] t;
when ωₚ(Δt)≠ω̅ₚ(Δt), the inspection robot slips when walking; and
it is determined whether the inspection robot slips by detecting and comparing ωₚ(Δt) and ω̅ₚ (Δt) in the step (2).

3. The slipping identification and intelligent self-adaptive control method for an inspection robot according to claim 1, wherein the slipping model is proposed according to a ratio between ωₚ (Δt) and ω̅ₚ(Δt) in the step (2), and a slip ratio σ is set in the slipping model;
$${σ ( Δ t ) = \frac{{ω}_{p} ( Δ t )}{{ϖ}_{p} ( Δ t )} = \frac{{rN}_{p} {n}_{w}}{{RN}_{w} {n}_{p}} \vert}_{Δ t} ,$$
σ(Δt) represents the slip ratio of the walking wheel within the period Δt;
a slipping state S is defined in the slipping model, and five types of slipping states are classified according to the slip ratio:
1) when Nₚ<0, σ<0, the walking wheel is in a slipping-down state, and S=S_{g};
2) when σ=0 and N_{w}>0, the walking wheel is in a full-slip state, and S=S_{b};
3) when 0<σ<1 and N_{w}>0, the walking wheel is in a light-slip state, and S=Sₛ;
4) when σ=1 and N_{w}>0, the walking wheel is in a normal walking state, and S=Sₙ;
5) when N_{w}=0, σ=∞, the walking wheel is in a locked state, and S=S₁.

4. The slipping identification and intelligent self-adaptive control method for an inspection robot according to claim 3, wherein in the step (3), a self-adaptive slip control is performed by using a two-dimensional fuzzy control method; the pressing wheel is driven by a pressing motor to press the cable on the walking wheel, degree of pressing the cable on the walking wheel by the pressing wheel is adjusted by adjusting a stroke of the pressing motor, and the larger the stroke of the pressing motor, the greater the degree of pressing the cable on the walking wheel; and
a slope θ of the cable and the slip ratio σ are regarded as input of the fuzzy control, and the stroke x of the pressing motor is regarded as output, a variable domain and a membership function are first determined for the slope σ of the cable and the slip ratio σ, and then a variable domain and a membership function are determined for the stroke x of the pressing motor.

5. The slipping identification and intelligent self-adaptive control method for an inspection robot according to claim 4, wherein in rolling travel, the inspection robot has an effective slope range of σ∈[−35°, 35°] and a slip ratio range σ∈(−∞, +∞), the slipping state of the inspection robot is S∈{S_{g}, S_{b}, S [symbol] , Sₙ, Sₜ}, the domain E [symbol] of the slope θis {−35, −25, −15, 0, 15, 25, 35}, and corresponding linguistic variables are NB, NM, NS, ZO, PS, PM, and PB; and the domain E [symbol] of the slip ratio σ {−∞, 0₋, 0₊, 1, +∞}, and corresponding linguistic variables are NB, NS, ZO, PS, and PB; and
a triangle membership function is selected to obtain the membership function of the slip ratio.

6. The slipping identification and intelligent self-adaptive control method for an inspection robot according to claim 5, wherein a method of determining the variable domain and the membership function of the stroke x of the pressing motor comprises:
determining the domain Eₓ of the stroke x of the pressing motor as {−13.6, −8.4, −4.2, 0, 4.2, 8.4, 13.6}, and determining the corresponding linguistic variables as NB, NM, NS, ZO, PS, PM, and PB;
fuzzy control rules being expressed as: and
Rₜ: if θ is Aᵢ and σ is Bᵢ, then uᵢis Cᵢ
a fuzzy relationship corresponding to the fuzzy control rules being:
$$R = {R}_{1} ⋃ {R}_{2} … ⋃ {R}_{n} = {{⋃}_{i = 1}}^{n} {R}_{i}$$
wherein Rᵢ represents an i^{th} control rule, uᵢ represents the stroke xᵢ of the pressing motor, Aᵢ represents a fuzzy subset of the linguistic variables corresponding to θ in the domain thereof, Bᵢ represents a fuzzy subset of the linguistic variables corresponding to σ in the domain thereof, and Cᵢ represents a fuzzy subset of the linguistic variables corresponding to u in the domain thereof.

7. The slipping identification and intelligent self-adaptive control method for an inspection robot according to claim 4, wherein the inspection robot is provided with a tilt angle sensor, and the tilt angle sensor is configured to measure the slope θ of the cable.

8. The slipping identification and intelligent self-adaptive control method for an inspection robot according to claim 6, wherein the self-adaptive slip control method based on the two-dimensional fuzzy control method comprises: performing fuzzy processing on the slope θ of the cable and the slip ratio σ, and performing fuzzy processing in conjunction with the fuzzy control rules to obtain an output stroke, wherein the stroke reaches the pressing motor, such that the pressing motor executes the stroke.

9. The slipping identification and intelligent self-adaptive control method for an inspection robot according to claim 1, wherein in this method, a communication connection is established between the inspection robot and a base station, the inspection robot transmits a slipping state to the base station, and the base station transmits a remote control command to the inspection robot, the remote control command comprising a command of adjusting the degree of pressing for the pressing wheel.
